(19) United States
(12) Patent Application Publication
(10) Pub. No.: US 2014/0340301 A1
(43) Pub. Date: Nov. 20, 2014

(54) HAND MOTION-BASED DEVICE CONTROL

(71) Applicants: Ken CLEMENT, Kingston (CA); Lowell MISENER, Kingston (CA)

(72) Inventors: Ken CLEMENT, Kingston (CA); Lowell MISENER, Kingston (CA)

(21) Appl. No.: 14/188,968

(22) Filed: Feb. 25, 2014

Related U.S. Application Data
(60) Provisional application No. 61/824,453, filed on May 17, 2013.

(51) Int. Cl. G06F 3/01

(52) U.S. Cl. CPC G06F 3/014
USPC 345/156

(57) ABSTRACT

The present invention seeks to provide a user interface for use with a pair of gloves that controls at least one function of a device. The gloves are constructed and arranged to restrict the use of individual fingers of a wearer. The user interface comprises a sensor operatively configured to detect and transmit wearer input mediated through specific hand motions performed by the wearer. A processor is in operative communication with the sensor such that the processor is configured to receive, interpret, and process wearer input. Specific hand motions are detected by the sensor, transmitted to the processor, interpreted to correspond to at least one specific function of the device, and processed to execute the at least one specific function.

### CORRESPONDING APPLICATIONS

This application is a non-provisional application of U.S. Provisional Application No. 61/824,453 filed on May 17, 2013.

### FIELD OF THE INVENTION

The present invention generally relates to a system for control of a device using hand motions. More specifically, the present invention provides a user interface for control of a device using hand motions while wearing gloves that limit hand or finger use.

### BACKGROUND

Various forms of hand protection are worn in various circumstances. For example, gloves or mittens may be worn to protect the hands in cold conditions and climates. Gloves or mittens may be worn to protect the hands during certain activities involving handling of hot items, such as necessary during cooking or baking. Many sports activities also require the use of protective hand equipment, usually to protect the hands from potentially dangerous impacts. It can be desirable to operate some electronic device while wearing hand protection, where in many cases the hand protection interferes with, or limits, the use of individual fingers. Yet hand protection may reduce the dexterity of the wearer and inhibits the manipulation of buttons, switches, knobs, dials, etc., that control or operate certain electronic devices. Therefore, there is a need for a user interface to operate electronic devices while wearing hand protection.

Predominantly, voice activation technology has been widely employed to accomplish hands-free operation of electronic devices. There are circumstances where alternative means would be preferred.

In the case of hand protection worn for weather conditions, such as cold winter conditions, it may be desirable or necessary to operate or activate some electronic device without removing the hand protection. For example, it may be necessary to activate a cellular phone to receive incoming calls, or to activate or deactivate a flashlight.

In sporting activities, accurately measuring athletic performance is often desirable. For combat sports, such as boxing, measuring parameters such as the number of strikes landed, the power landed strikes, or the number of strikes landed within a specific time interval, are particularly desirable. When an individual is training alone, the operation of equipment to measure performance be difficult because the gloves worn interfere with the manipulation of such equipment. For example, a simple task such as starting and stopping a timer or stopwatch is challenging. Furthermore, gloves worn during sporting activities are often not easily removed and it would be inconvenient to do so during an event or training, even to operate relatively simple controls for a device.

### SUMMARY OF THE INVENTION

The present invention seeks to provide a user interface for use with a pair of gloves that controls at least one function of a device. The gloves are constructed and arranged to restrict the use of individual fingers of a wearer. The user interface comprises a sensor operatively configured to detect and transmit wearer input mediated through specific hand motions performed by the wearer. A processor is in operative communication with the sensor such that the processor is configured to receive, interpret, and process wearer input. Specific hand motions are detected by the sensor, transmitted to the processor, interpreted to correspond to at least one specific function of the device, and processed to execute the at least one specific function.

### BRIEF DESCRIPTION OF THE DRAWINGS

Embodiments of the present invention will now be described, by way of example only, with reference to the attached Figures, wherein:

FIG. 1 is a schematic representation of a single glove and related components in accordance with an embodiment of the present invention;

FIG. 2 is a schematic representation of the recognition/processing of hand motions using a single glove in accordance with an embodiment of the present invention;

FIG. 3 is a schematic representation showing a hand motion with a pair of gloves in accordance with another embodiment of the present invention;

FIG. 4 is a schematic representation showing a hand motion and interaction between a pair of gloves in accordance with another embodiment of the present invention; and

FIG. 5 is a schematic representation showing hand motions of a pair of gloves and the interaction of various components in accordance with an embodiment of the present invention.

### DETAILED DESCRIPTION

In describing implementations of the user interface, the following terminology will be used with the definitions and explanations set forth below. Other terminology and definitions may also be found throughout this document as well.

As used herein, the term “gloves” is used to refer to any coverings to be worn on the hands of an individual. The gloves may be what are commonly understood to be gloves, i.e. hand coverings that have individual finger sections but are also used to refer to what are commonly known as mittens, or mitts, i.e., hand coverings having a separate thumb section with another section containing the remaining four fingers. Mittens without a thumb section are also contemplated within the glove definition. Gloves, as used herein are typically worn to offer protection. The gloves, due to their protective function, restrict or limit the use of individual fingers and thereby interfere with the ability of the wearer to operate devices through manipulation of buttons, switches, dial, and the like. The gloves may be those typically worn for protection from weather, high temperature, low temperature, lacerations, or impacts. The gloves may also be any number of sporting gloves, worn to protect the wearer mainly from impacts, particularly repetitious impacts such as boxing gloves.

As used herein, the phrase “hand motions” is used to refer to specific motions by one or both hands. Preferably, the hand motions will be distinct so as not to be confused with one another (in the case of more than a single hand motion) or be performed erroneously or unintentionally during regular wear and use of the gloves. Preferred hand motions are a single clap and/or tap using both hands together and a double clap and/or tap using both hands together. Other hand motions may be used to complement the particular regular use of the gloves in various uses for control of specific devices. Separate distinct hand motions may be used to control separate distinct functions of the device.

As used herein, the term “device” is used to refer to a component used to perform a specific function or functions. The device may be physically associated with the gloves or may be remotely located. In aspects where the device is remote from the gloves, a connection and/or communication with other components associated with the gloves, or with other remotely located components, may be through wireless technology. In aspects where the device is associated with the gloves, the device may be wired to other components associated with the gloves. The device may also use a combination of wired and wireless connections to various components to facilitate the desired communication between components. The device may be any device that performs at least one function that can be controlled electronically. For example, the device may be a light source such as a room light, a portable light source, such as a flashlight, or a body-mounted light source, such as a head- or a hand-mounted light. As another example the device may be a cellphone where the function is answering an incoming call. Examples of devices related to sporting activities include, but are not limited to, stop watches, timers, cameras, and event counters. Event counters may be used to record, track, or count any number of measurable parameters of interest. A preferred event counter is a strike counter used to keep track of the number of strikes landed on a target such as a heavy bag or to keep track of strikes thrown, such as “shadow-boxing”. Preferred strike counters are punch counters and kick counters. In the aspect where the device is a punch counter, the gloves would be similar to typical boxing gloves and the counter would be associated with the gloves. In the aspect where the device is a kick counter, the counter would be associated with articles similar to common shin-pads or foot-pads where gloves similar to typical boxing gloves would also be worn. In some aspects, the user interface in the gloves would be used to control counters in both the gloves and the shin- or foot-pads. The device may be a physical device performing at least one function. Alternatively, the device may be a software-enabled function or collection of functions.

As used herein, the term “sensor” is used to refer to components that detect the hand motions. The sensor is associated with the gloves and may be contained within the gloves. Many types of sensors that are known in the art may be used as components to detect hand motions, directly or indirectly, and include but are not limited to: acceleration, vibration, electric current, piezoelectric, pressure, fluid pressure, force, velocity, proximity, capacitance, gyroscopic, clinometer, laser rangefinder, linear variable differential transformer, photoelectric, sudden motion sensor, tilt, or full motion. The sensor may include multiple different sensor types. Additionally, the sensor may be configured to measure parameters in one, two, or three dimensions. The actual hand motion may be detected as at least one particular property that is in turn transformed or translated into at least one other format to facilitate the final signal. The sensor is also configured to transmit detected signals. Depending on the nature of the particular device, other sensors which are not associated with the user interface sensor may be used as part of that device, for example, in the case of a strike counter the sensor or sensors that detect strikes may be distinct from the sensor that detect the hand motions. The sensor collectively refers to at least one sensor that may be utilized to detect hand motions and at least one sensor that may be utilized as a device.

As used herein, the term “processor” is used to refer to at least one component that functions to receive, interpret, and process the signals from the hand motions, that differentiates striking motions from non-striking motions and, in turn, based on the determination of the hand motions that controls at least one function of at least one device. The processor may be a single electronic component, for example a typical computer microprocessor or operatively programed to perform the desired activity or a computer running suitable software. Alternatively, the processor may be multiple components that may be connected. The processor is configured to receive signals from the sensor and to transmit signals. Signals may be transmitted to other components of the processor, to at least one device, to at least one display, to a computer for storage or manipulation of data, or to any combination thereof. In embodiments where the device, as described herein, is a software-enabled function, this function may be a component of the processor.

The user interface may also employ a menu navigation function facilitated by the processor in the control of a device through hand motions. In one aspect, repeating a first specific hand motion may cycle through menu options while a second specific hand motion will activate some function of the particular device based on the active menu selection. For example, the device may be a cellphone and one specific hand motion may activate the contact list of phone numbers stored in the cellphone, where repeating the specific hand motion cycles through the contact list and a second distinct hand motion activates the cellphone to call the selected contact.

As used herein, the term “display” is used to refer to any means to display select outputs. The display may be located on the gloves for convenient viewing by the wearer. Alternatively, the display may be remote from the gloves and may be positioned so that it may be easily viewed by the wearer at any desired time. In addition, select output representing data of interest may be sent to a separate device for storage or further manipulation. Many suitable types of display technologies are known, including but not limited to: electronic ink (E-ink), light-emitting diode (LED), liquid crystal display (LCD), and organic light-emitting diode (OLED). The display may be set to display any convenient information pertaining to the device to be controlled. In embodiments where the hand motions control the device via a menu, the menu selections may be shown on the display. The power or charge level of the device and/or glove components may also be displayed. Displaying any other such device parameters, including maintenance parameters that would keep the user apprised of the state of the glove or device, is contemplated by the present invention.

The present invention provides a user interface to control a device using hand motions while wearing gloves that limit the use of the hands or fingers of the wearer in such a way as to interfere with the ability of the wearer to operate devices through fine motor control, such as pressing buttons, using switches, operating touch screens, etc. The gloves have incorporated a sensor being at least one type of sensor to detect hand motions and transmit data to a processor that interprets and processes the hand motion data and carries out control of a device associated with the gloves. The sensor, processor, and device may be in operative communication through wired or wireless technology.

A power source may be incorporated within the gloves to power all necessary components for the user interface and associated devices or the associated devices may be powered separately. The power source may be a typical disposable battery requiring replacement or may be rechargeable. The gloves may have a port to allow charging of the user interface, for example through a USB port. The display may have an indicator for battery or charge remaining.

The control of a device may be simple or complex and may utilize multiple distinct hand motions to carry out various control aspects. A simple control involves activation/deactivation or on/off. A more complex control scheme may employ a menu system as part of the processor to facilitate control of various parameters or functions of the device.

For example a specific hand motion may turn on a device such as a light source, while the same hand motion will turn off the light source. Alternatively, a first hand motion may turn on a light source, a second hand motion may cycle through light source power levels, and the first hand motion may turn off the light source.

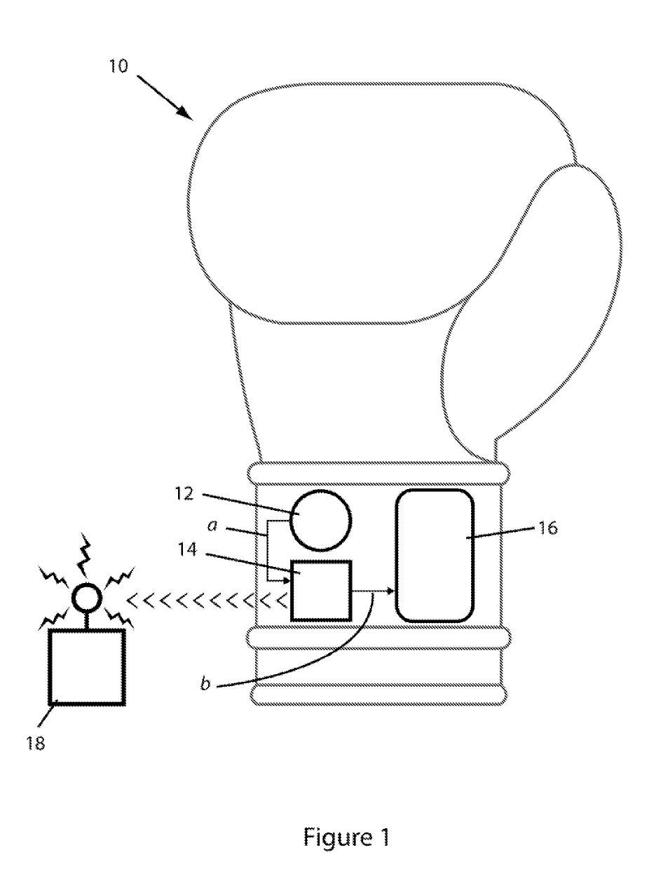

According to one embodiment as shown in FIG. 1, a boxing-type glove 10 is provided having incorporated therein, a sensor 12, a processor 14, and a display 16. Glove 10 is such that, when worn by an individual, the individual is not able to use their fingers to perform tasks requiring the use of individual fingers. Thus, when wearing gloves 10, the individual is unable to efficiently, if at all, operate devices through pushing buttons, flipping switches, turning dials, etc. Sensor 12 is configured to detect hand motions performed by the wearer and, being in communication with the processor 14, is configured to transmit data to the processor 14 (as shown by the arrowed line segment a connecting the sensor 12 to the processor 14). The processor 14 may be configured to perform any number functions necessary facilitate reception of hand motions, interpretation of hand motions including differentiating punches from non-punches, and sending data. Data may be sent, as shown in FIG. 1, to a wireless receiver 18 (indicated as “<<<”) and to a display 16 (as shown by the arrowed line segment b connecting the processor 14 to the display 16).

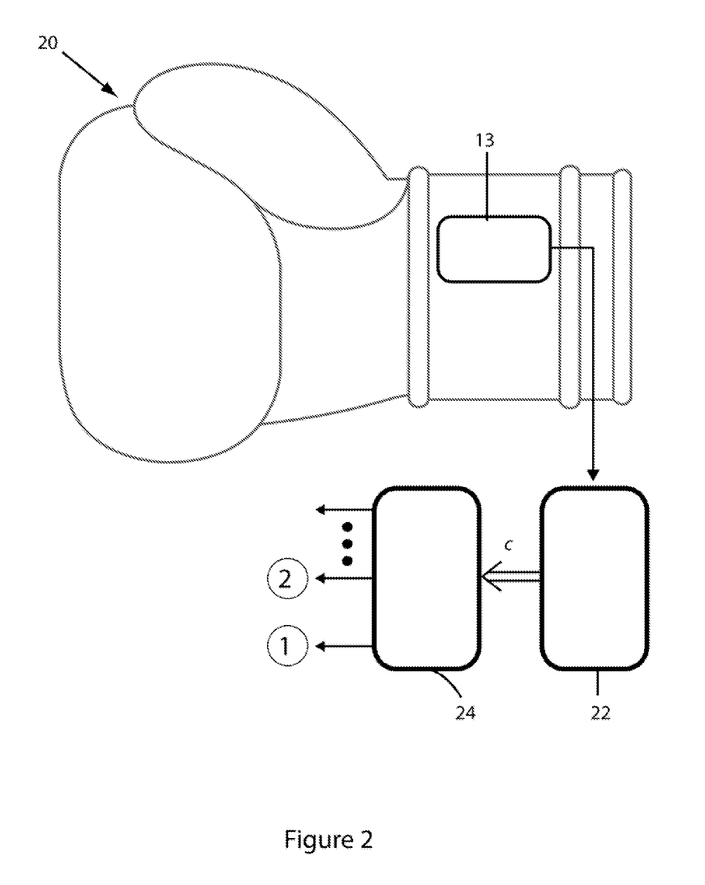

FIG. 2 shows a glove according to another embodiment similar to that of FIG. 1. A boxing-type glove 20 is provided having incorporated therein a sensor and a processor (shown combined as element 13 incorporated in glove 20). Element 13 is shown in exploded view as a sensor 22 and a processor 24. A sensor 22 is in communication with a processor 24 as indicated by arrow c which may be through wired or wireless interaction. A processor 24 is able to receive signals from a sensor 22 and differentiate between different hand motions, indicated as \textcircled{1} and \textcircled{2}. For example, hand motion \textcircled{1} may be determined by a processor 24 to correspond to a start/stop command for a counting function of a processor 24, while hand motion \textcircled{2} may be determined to be a strike/punch to be counted by the counting function of a processor 24 as indicated as , with three strikes counted being shown. A processor 24 may store the counted punches and may also send desired output to a display (not shown in FIG. 2).

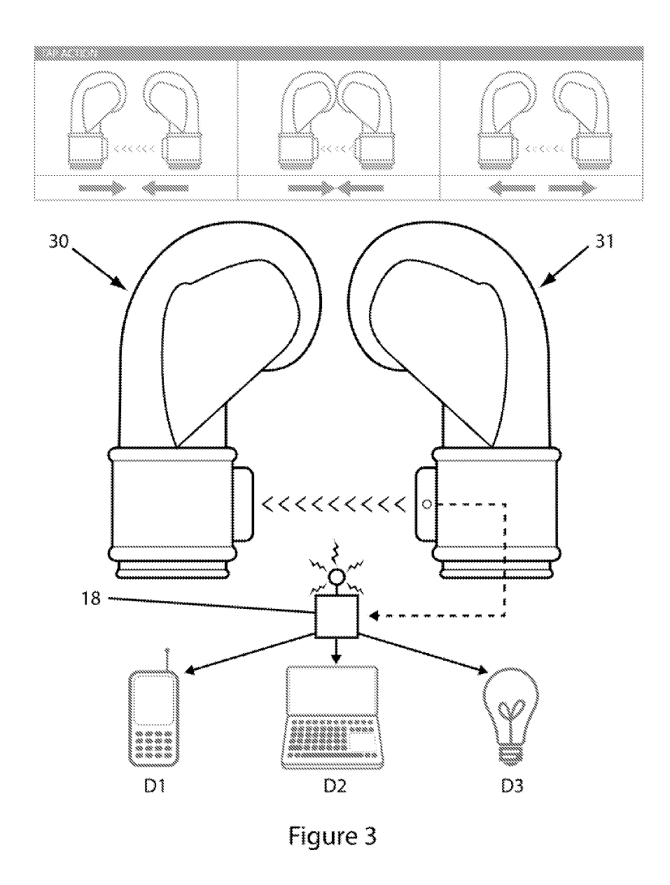

FIG. 3 shows another embodiment of the user interface. A tap action series shows a tapping action hand motion. A single tap may be differentiated from a double tap and each may be associated with a different function through the processor (not shown in FIG. 3). A pair of gloves 30 and 31 is shown, wherein glove 31 functions as a master and glove 30 functions as a slave through wireless communication (indicated as<<<). In this embodiment, master glove 31 detects and processes hand motions (single or double tap motions, for example) and sends wireless instruction data to slave glove 30. The Master glove also synchronizes the Slave glove to the Master glove. Master glove 31 is also in operative communication with and controls at least one device function through a processor (not shown in FIG. 3). At least one device may be incorporated in the glove or may be remote, shown as devices D1, D2, or D3 (a cellphone, a personal computer, or a light source, respectively, for example) (indicated as by dashed lines - - - ) via wireless receiver 18. A display may also be in communication with the user interface as at least one device controlled by the user interface or may be in addition to at least one device. The display may show any output desired including, but not limited to, the user interface battery charge remaining, the associated device battery charge remaining, wireless connectivity status, or any device-specific data desired.

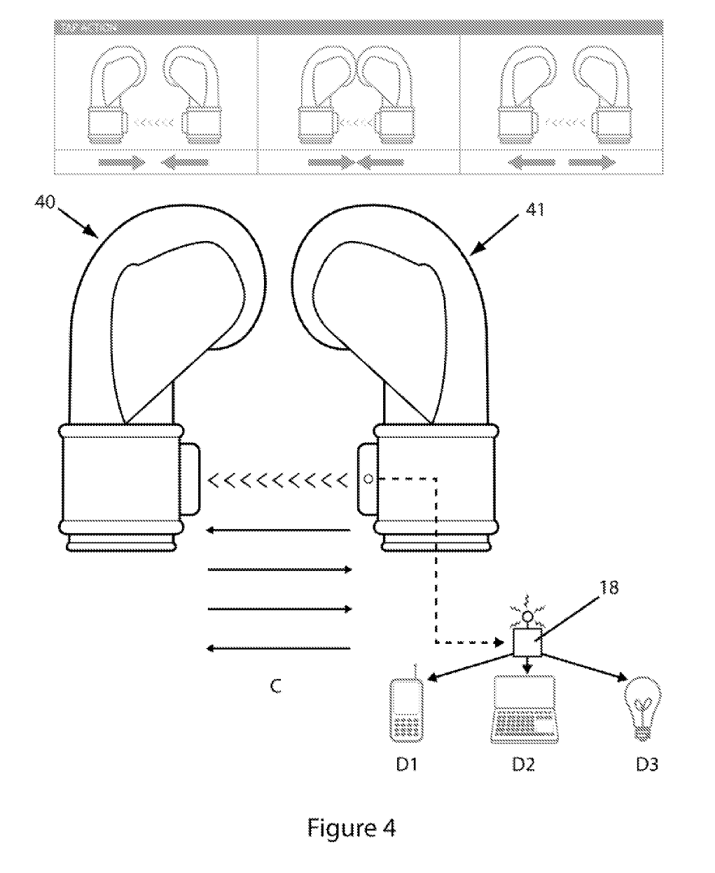

FIG. 4 shows an embodiment similar to that of FIG. 3. A tap action series shows a hand motion being a tapping action the same as shown in FIG. 3. A pair of gloves 40 and 41 is shown, wherein master glove 41 functions as a master to communicate with and control slave glove 40. However, unlike the embodiment shown in FIG. 3 where master glove 31 communicates with and controls slave glove 30, the communication between gloves 40 and 41 is bi-directional, as indicated by arrowed line segments C. The slave glove 40 can carry out select functions independently and send data to master glove 41. Glove 41 is in communication with and controls at least one device function shown (including slave glove 40) through a processor (not shown in FIG. 3) and transmits data to at least one device D1, D2, or D3 (a cellphone, a personal computer, or a light source, respectively, for example) (indicated as - - - ) via wireless receiver 18. Alternatively, glove 41 may communicate directly with and control at least one devices incorporated within the gloves.

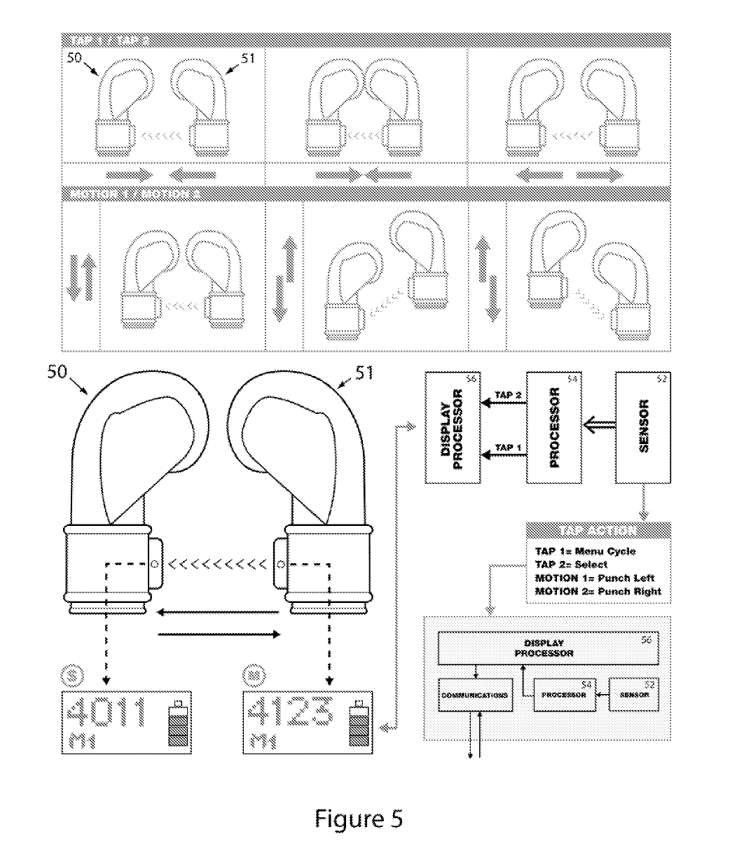

FIG. 5 shows additional aspects of one embodiment of the user interface. A TAP 1/TAP 2 series shows a hand motion being a tapping action as shown in FIGS. 3 and 4 which may be a single tap of the gloves together or a double tap of the gloves together. The threshold for registering a double tap may be set as desired (for example 0.5 seconds). A MOTION 1/MOTION 2 series shows hand motions that may be detected by sensors (not shown) and interpreted by the processor (not shown) to be a punching action with each of the gloves. A pair of gloves 50 and 51 is shown, wherein master glove 51 functions as a master to communicate with and control slave glove 50. The flow chart schematic of FIG. 5 shows the interaction between the user interface components. The SENSOR 52 detects hand motions and communicates data to the PROCESSOR 54 which can distinguish between hand actions that are counted by the counter device (which may be considered a function of the PROCESSOR) and between device or menu control actions. The TAP ACTION can be any of TAP 1 (which may be, for example, a double tap), TAP 2 (which may be, for example, a single tap), MOTION 1 (which may be, for example, a left glove punch), and MOTION 2 (which may be, for example, a right glove punch). TAP 1 may be used to cycle through menu options, which may be another function of the PROCESSOR; TAP 2 may be used to active the currently active menu selection; MOTION 1 may be counted as a punch for that glove; and MOTION 2 may be counted as a punch for that glove. The PROCESSOR is in communication with a DISPLAY PROCESSOR 56 which may be present on each glove, or alternatively a single DISPLAY may show data from both gloves. For example, in addition to showing a tally of punches counted, the battery power or the currently selected power level for each of the master glove \textcircled{M} and the slave glove \textcircled{S}. The DISPLAY PROCESSOR may also, through COMMUNICATIONS, may transmit output to remote devices which may be additional display devices or computers for storing data.

The present invention provides a user interface to control functions of at least one device while wearing gloves that interfere with the use of the wearer's fingers to manipulate device controls such as buttons, switches, knobs, dials, etc. The user interface includes gloves worn by a user, a sensor having at least one sensor associated with the gloves, a processor associated the gloves, and at least one device associated with the gloves. In one embodiment, the sensor and processor are part of, or incorporated within, the gloves. At least one devices may be incorporated within the gloves or may be remote from the gloves, being in communication through wired or wireless connection. At least one of the sensors of the sensor functions to detect hand motions. The processor functions include processing hand motions and executing control actions for at least one associated device. A display may be associated with the user interface to display desired output related to the user interface.

In another embodiment, the gloves are for use in combat sports, such as boxing, involving punching or other hand strikes, and the device is a counter for tracking performance such as the number of strikes thrown. The user interface may have a charging system such as through a conventional USB mini input. For use the gloves are disconnected from the charging source, switched to the “ON” position through a switch that may be present on one or both gloves and placed on the user's hands. One location for the sensor, processor, and display are in the wrist straps of the gloves as this location is not typically subjected to impacts resulting from the use of the gloves during sport. The gloves default state coming from a CHARGE-ON switch or waking from a BATTERY SAVING SLEEP MODE (for example, this may happen when the user interface is not used for 120 seconds) may be at the USER POWER LEVEL SELECTION. The preferred hand motions for controlling the counter device is a clapping and/or tapping motion. Double tapping the gloves together increments the Power Level up by one until the maximum is reached, then it is cycled back down to 1 (MENU CYCLING MODE). When the desired Power Level is reached, depending on the type of activity to be performed (for example, shadow boxing, speed bag work, heavy bag training) the user does a single tap start the punch counting function of the device (which may be performed by the processor or may be a distinct component (MENU SELECTION/ACTIVATION). The display may indicate that the counter device in each glove is ready to begin detecting and counting punches by displaying “GO” for example. The display may also display the Power Level during MENU CYCLING MODE and SELECTION/ACTIVATION, the charge level of the user interface, and the counter output or any other desired data. Each glove may have its own display showing data for that glove or a single glove may have a display showing desired output for both gloves. When the user is done the sporting activity, they can double tap the gloves to Exit—a single tap does nothing when the gloves are counting. This brings the user interface back to the initial default state and the display may provide an indication that the counter devices in each glove are done detecting and counting punches by showing “DONE” for example. At this point, when the user is done, they can either connect the gloves to the charger (change the switch state to Charge), or do nothing and the Gloves will go to Low Power SLEEP MODE—tapping the gloves together in any fashion “wakes” them up.

In an alternative embodiment, counter devices and sensor are incorporated within other/additional equipment. Shin pads or foot pads may be used in addition to gloves where the user may want to count kicks. If gloves are worn the user interface may be used to control the counter devices shin or foot pads. The processor in this embodiment may still be associated with the gloves or may also be associated directly with the shin or foot pads. When multiple devices are present, for example, two punch counters (one in each glove) and two kick counters (one in each shin/foot pad), the user interface may utilize additional menu selections to selectively control the various devices as desired. Additionally, additional hand motions may be used to control various aspects of the multiple devices.

The above-described embodiments are intended to be examples of the present invention and alterations and modifications may be effected thereto, by those of skill in the art, without departing from the scope of the invention which is defined solely by the claims appended hereto, which should be given the broadest interpretation consistent with the description as a whole.

What is claimed is:

1. A user interface for control of at least one function of a device for use with a pair of gloves, the gloves having a body with a wrist portion, a thumb portion, and a finger portion, where the finger portion restricts the use of individual fingers of a user, the user interface comprising:
a sensor operatively configured to detect and transmit wearer input by sensing specific hand motions made by the user; and
a processor in operative communication with the sensor and configured to receive and process wearer input, such that each user input is interpreted to correspond to at least one specific function of the device and processed to execute the at least one specific function.

2. The user interface of claim 1, wherein the device is remote from the pair of gloves, the device being configured to wirelessly communicate with the pair of gloves.

3. The user interface of claim 1, wherein the device is incorporated within the pair of gloves.

4. The user interface of claim 3, wherein a first glove of the pair of gloves is configured to operate as a master device and control the operation of a second glove of the pair of gloves, the pair of gloves being in operative communication with each other.

5. The user interface of claim 4, wherein a first user input is associated with a first specific function of the device and a second user input is associated with a second specific function of the device.

6. The user interface of claim 5, wherein the first user input is a double clap motion.

7. The user interface of claim 5, wherein the first user input is a single clap motion.

8. The user interface of claim 5, wherein the first specific function cycles through menu options of a menu module.

9. The user interface of claim 5, wherein the second specific function executes the current menu option of a menu module.

10. The user interface of claim 1, wherein each glove of the pair of gloves includes a sensor and the device is a punch counter configured to detect punches landed by each glove.

11. The user interface of claim 1, further comprising a display in operative communication with the processor and configured to display to the user a number of punches landed by at least one of the pair of gloves.

12. The user interface of claim 11, wherein the display is configured to display to the user a number of punches landed by each glove.
